(19) United States
(12) Patent Application Publication
(10) Pub. No.: US 2016/0362111 A1
(43) Pub. Date: Dec. 15, 2016

(54) DRIVER AWARENESS SENSING AND INDICATOR CONTROL

(71) Applicant: JAGUAR LAND ROVER LIMITED, Warwickshire (GB)

(72) Inventors: Matt Jones, Portland, OR (US); Sebastian Aleksander Paszkowicz, Whitley (GB)

(21) Appl. No.: 14/737,902

(22) Filed: Jun. 12, 2015

(51) Int. Cl. B60W 40/08

(52) U.S. Cl. CPC B60W 40/08; B60W 2040/0818

(57) ABSTRACT

An illustrative example embodiment of a system includes object detecting means for providing an indication of an object in a vicinity of a vehicle; at least one indicator means for providing an indication regarding the detected object to a driver; gaze detecting means for providing an indication of the vehicle driver's gaze; brain activity detecting means for providing an indication of the driver's brain activity; and control means for controlling any indication from the indicator means regarding the detected object based upon an indication from the gaze detecting means and the brain activity detecting means corresponding to an estimation of driver awareness of the detected object.

### TECHNICAL FIELD

The present disclosure relates to vehicle driver awareness sensing and indicator control based on an estimation of driver awareness. Aspects of the invention relate to a system, a vehicle and a method.

### BACKGROUND

Modern automotive vehicles include increasing technology for a variety of purposes. There are known systems that assist drivers in avoiding collisions, for example. A variety of sensor and camera technologies are available to assist a driver in determining that an object or another vehicle is in or likely to enter the potential path of the vehicle, such as when the driver intends to move in a reverse direction or change lanes. Such systems may alert the driver regarding a condition near the vehicle through visual or audible indications. For example, lane change assistance systems include sensors that detect the presence of an object or another vehicle on the side of the vehicle. A light may be activated to indicate the presence of such an object or another vehicle. If a driver activates a turn signal in the direction of the detected object or vehicle, the light may be activated to flash or brighten to provide a warning to the driver that the lane is not clear.

A variety of other warnings or indicators may be provided to drivers depending on which systems are provided on a particular vehicle. With advances in technology such assistance is more available but there are potential drawbacks. For example, if too many warnings or indications are provided, that which is intended to assist the driver may annoy or distract the driver in an undesirable manner. Some such systems may be inactivated manually based on driver preference but then the possible benefit of an inactivated system is lost entirely. There is a need for better control over vehicle technology, such as how a vehicle warning system operates to avoid giving a driver too much or unwanted information.

### SUMMARY

Aspects and embodiments of the invention provide a system, a method and a vehicle as claimed in the appended claims.

According to an aspect of the invention there is provided a system comprising object detecting means for providing an indication of an object in a vicinity of a vehicle; indicator means for providing an indication regarding the detected object to a driver; gaze detecting means for providing an indication of the vehicle driver's gaze; brain activity detecting means or providing an indication of the driver's brain activity; and control means for controlling any indication from the indicator means regarding the detected object based upon an indication from the gaze detecting means and the brain activity detecting means corresponding to an estimation of driver awareness of the detected object

In an example embodiment having one or more features of the system of the previous paragraph, the object detecting means comprises at least one object detector, such as a stereoscopic camera system, a radar detector or an ultrasound detector; the gaze detecting means comprises at least one gaze detector, such as a camera; the brain activity detecting means comprises at least one brain activity detector, such as a brain wave sensor that is configured to detect small electrical impulses or signals indicative of brain activity through an individual's skin; and the control means comprises at least one controller, such as a processor and a memory or data storage.

In an example embodiment having one or more features of the system of either of the previous paragraphs the control means does not provide any indication from the indicator means when the indication from the gaze detecting means and the brain activity detecting means correspond to an estimation that the driver is aware of the detected object.

In an example embodiment having one or more features of the system of any of the previous paragraphs, the indicator means provides an indication regarding the detected object, and the control means alters at least one characteristic to reduce an effect of the indication regarding the detected object when the indication from the gaze detecting means and the brain activity detecting means correspond to an estimation that the driver is aware of the detected object, or the control means alters at least one characteristic to increase an effect of the indication regarding the detected object when the indication from the gaze detecting means and the brain activity detecting means correspond to an estimation that the driver is unaware of the detected object.

In an example embodiment having one or more features of the system of any of the previous paragraphs, the indication regarding the detected object is at least one of audible or visible, the at least one characteristic is at least one of tone or volume if the indication regarding the detected object is audible, and the at least one characteristic is at least one of size, brightness, color or intensity if the indication regarding the detected object is visible.

In an example embodiment having one or more features of the system of any of the previous paragraphs, the object detecting means comprises at least one of a camera, a stereoscopic forward or rear looking camera system, one or more ultrasonic sensors, or one or more radar detectors.

In an example embodiment having one or more features of the system of any of the previous paragraphs, the gaze detecting means comprises at least one camera having a field of vision situated to capture images of the driver's eyes.

In an example embodiment having one or more features of the system of any of the previous paragraphs, the control means comprises: an electronic processor having an electrical input for receiving one or more signals from the object detecting means, the gaze detecting means and the brain activity detecting means, and an electronic memory device electrically coupled to the electronic processor, the electronic memory device having stored instructions; wherein controlling any indication from the indicator means comprises the processor being configured to access the memory device and execute the instructions such that the electronic processor is operable to determine an estimation of driver awareness of the detected object based on said signals received from the object detecting means, the gaze detecting means and the brain activity detecting means, and to control said indication based on said determined estimation of driver awareness.

In an example embodiment having one or more features of the system of any of the previous paragraphs, the control means determines an at least approximate direction of the driver's gaze based on the indication from the gaze detecting means. The control means determines an at least approximate position of the detected object relative to the driver. The control means also determines whether the direction of the driver's gaze corresponds to the driver looking toward the determined position of the detected object.

In an example embodiment having one or more features of the system of any of the previous paragraphs, the brain activity detecting means comprises at least one sensor configured to detect small electrical impulses or signals indicative of brain activity through the driver's skin.

In an example embodiment having one or more features of the system of any of the previous paragraphs, the control means comprises a processor and a data storage associated with the processor; and the processor places information in the data storage regarding detected objects and corresponding driver awareness estimations.

According to another aspect of the invention there is provided a vehicle comprising the system of any of the preceding paragraphs.

According to another aspect of the invention there is provided a method comprising: detecting an object in a vicinity of a vehicle, detecting a vehicle driver's gaze, detecting the driver's brain activity, automatically determining whether indications of the detected driver's gaze and brain activity correspond to an estimation of driver awareness of the detected object; and controlling any indication provided to the driver regarding the detected object based upon the determination regarding driver awareness.

An example embodiment having one or more features of the method of the previous paragraph may include not providing any indication regarding the detected object to the driver when the indications of the driver's gaze and brain activity correspond to an estimation that the driver is aware of the detected object.

An example embodiment having one or more features of the method of either of the previous paragraphs may include providing the indication regarding the detected object for the driver; and (i) altering at least one characteristic to reduce an effect of the indication regarding the detected object when the indications of the driver's gaze and brain activity correspond to an estimation that the driver is aware of the detected object, or (ii) altering at least one characteristic to increase an effect of the indication regarding the detected object when the indications of the driver's gaze and brain activity correspond to an estimation that the driver is unaware of the detected object.

In an example embodiment having one or more features of the method of any of the preceding paragraphs, the indication regarding the detected object is at least one of audible or visible. The at least one characteristic is at least one of tone or volume if the indication regarding the detected object is audible. The at least one characteristic is at least one of size, brightness, color or intensity if the indication regarding the detected object is visible.

An example embodiment having one or more features of the method of any of the preceding paragraphs includes using at least one of a camera, a stereoscopic forward or rear looking camera system, one or more ultrasonic sensors or one or more radar detectors for detecting the object.

An example embodiment having one or more features of the method of any of the preceding paragraphs includes using at least one camera having a field of vision situated to capture images of the driver's eyes for providing the indication of the driver's gaze.

An example embodiment having one or more features of the method of any of the preceding paragraphs includes determining an at least approximate direction of the driver's gaze based on the indication of the driver's gaze, determining an at least approximate position of the detected object relative to the driver, and determining whether the direction of the driver's gaze corresponds to the driver looking toward the determined position of the detected object.

An example embodiment having one or more features of the method of any of the preceding paragraphs includes using at least one brain wave sensor configured to detect small electrical impulses or signals indicative of brain activity through the driver's skin for providing the indication of the driver's brain activity.

An example embodiment having one or more features of the method of any of the preceding paragraphs includes storing information in a data storage regarding detected objects and corresponding driver awareness estimations.

According to another aspect of the invention there is provided a vehicle comprising detecting means and control means configured to perform the method of any of the preceding paragraphs.

Within the scope of this document it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 diagrammatically illustrates an example embodiment of a vehicle including a system designed according to an embodiment of this invention;

FIG. 2 schematically illustrates selected portions of a vehicle interior incorporating features of a system designed according to an embodiment of this invention;

FIG. 3 schematically illustrates components of an example embodiment of a driver awareness sensing system; and

FIG. 4 is a flow chart diagram that summarizes an example sensing and control strategy.

### DETAILED DESCRIPTION

Embodiments of this invention provide an estimation of whether a driver is aware of an object or situation in a vicinity of a vehicle. Embodiments provide automated and variable control over driver information devices based on sensing driver awareness. An example disclosed embodiment utilizes an estimation of driver awareness of an object that may present a potential hazard utilizing two sensing technologies and selectively controls a manner in which at least one device informs the driver of the object based on the estimation regarding the driver's awareness. With such embodiments it is possible to avoid providing a driver with too much notice of a detected object or potential hazard in a manner that might be annoying or distracting to the driver.

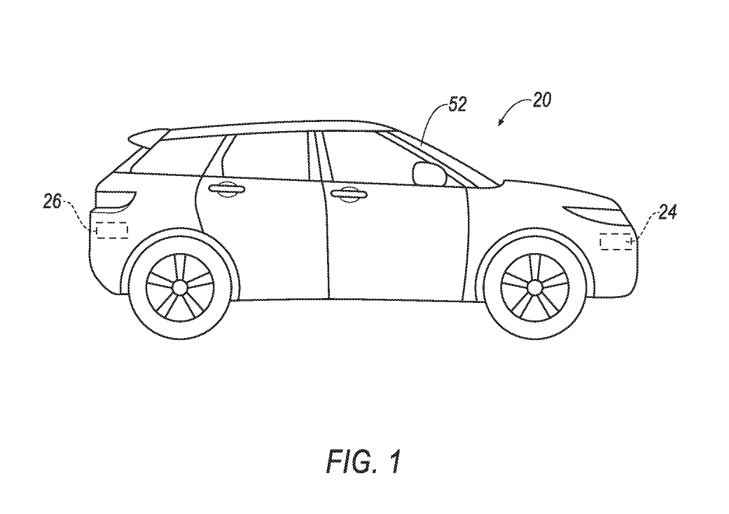

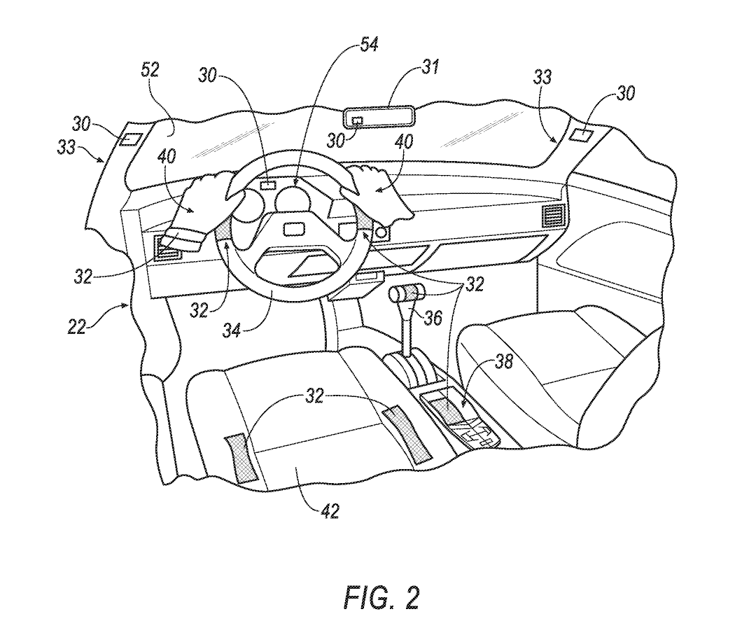

FIGS. 1 and 2 illustrate selected features of a vehicle 20 that includes a system 22 for determining a driver's awareness of an object or situation in a vicinity of the vehicle 20. Object detecting means 24 and 26 are provided on the vehicle 20 for detecting an object in a vicinity of the vehicle 20. The object detecting means 24 and 26 may comprise one or more sensors. Example embodiments include at least one of: at least one camera, at least one stereoscopic camera system, at least one ultrasonic sensor, or at least one radar detector. In one embodiment, the objecting detecting means 24 comprises a forward looking stereoscopic camera system and the object detecting means 26 comprises a rearward looking stereoscopic camera system. There are a variety of known devices useful for vehicle applications to detect objects in a vicinity of a vehicle. Those skilled in the art who have the benefit of this description will realize which type of detector will best meet their particular needs.

The object detecting means 24 and 26 are capable of providing an indication regarding a detected object or situation under a variety of circumstances. For discussion purposes, the phrase “detected object” should not be interpreted in a strict sense, but instead is intended to refer to a variety of situations or conditions that can be detected. Examples of detected objects include a physical object whether moving or stationary, an individual whether moving or stationary, or a driving surface condition.

The system 22 includes at least one gaze detecting means 30 for providing an indication of a driver's gaze. In some example embodiments, the gaze detecting means 30 comprises at least one camera having a field of vision situated to capture images of the driver's eyes. In FIG. 2, the gaze detecting means is situated in example possible locations within a vehicle interior, such as on a rear view mirror 31 or A pillar 33. The indications from the gaze detecting means 30 may provide information regarding a direction in which the driver is looking. An example eye tracking system that is camera based is available from Seeing Machines, Ltd. Such systems and known gaze tracking algorithms are useful in embodiments of the example system 20.

The example system 20 includes at least one brain activity detecting means 32 for providing an indication of the driver's brain activity. The brain activity detecting means 32 comprises at least one sensor configured to detect small electrical impulses or signals indicative of brain activity or electric-based indications of brain activity. An example embodiment includes sensors available from Freer Logic, LLC, such as those disclosed in United States Patent Application Publication No. 2012/0232410, which detect small electrical impulses or signals indicative of brain activity using sensing electrodes situated against an individual's skin.

In the example of FIG. 2, there are a variety of brain activity sensors 32 situated within the vehicle interior. Example brain activity sensors 32 are situated on the steering wheel 34, gear shift 36 and center console interface device 38. Such sensors 32 may be hard wired into the system 20 or communicate using a known wireless communication technology. Another example brain activity sensor 32 may be worn by the driver and communicate wirelessly with the system 22. One such example is shown in FIG. 2 on the driver's wrist near the driver's hands schematically shown at 40. Several of the sensors 32 shown in FIG. 2 are situated for contact with the driver's hands 40 under a variety of circumstances. The example of FIG. 2 also includes a brain wave activity sensor arrangement situated on the driver's seat 42 as an alternative or additional sensor configuration.

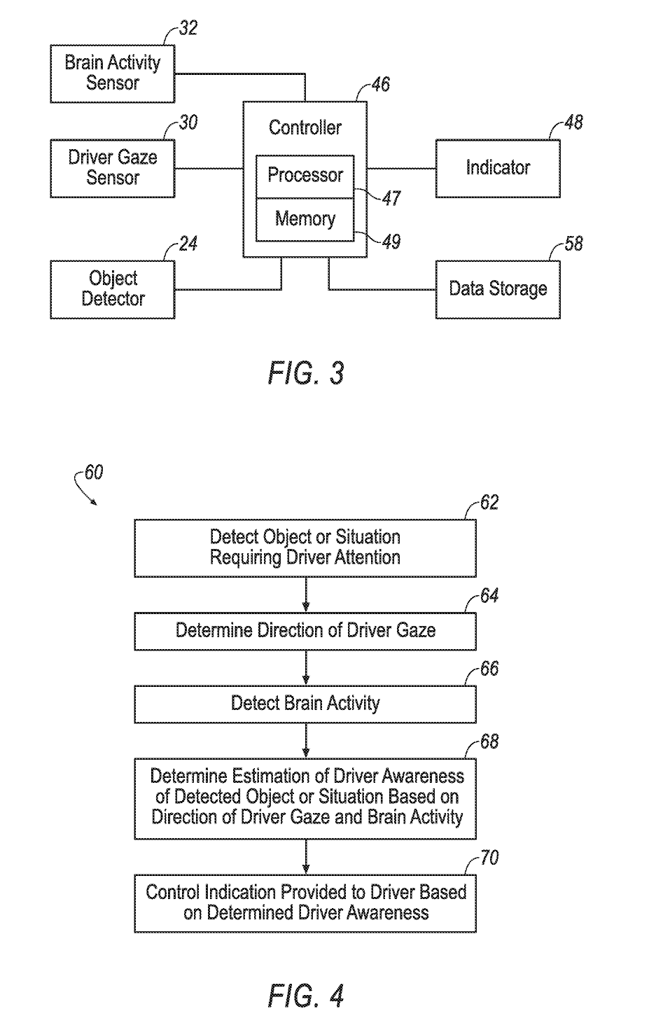

Referring to FIG. 3, a control means comprising at least one electronic controller 46 controls operation of at least one indicator means 48 that is configured to provide at least one type of indication to a driver regarding a detected object. R is to be understood that the electronic controller described herein can comprise a control unit or computational device having one or more electronic processors (e.g., a microprocessor, a microcontroller, an application specific integrated circuit (ASIC), etc.). The system may comprise a single electronic controller or alternatively different functions of the controller may be embodied in, or hosted in, different controllers. As used herein, the term “controller” will be understood to include both a single controller and a plurality of controllers collectively operating to provide the required control functionality. A set of instructions could be provided on a memory associated with the or each controller which, when executed, cause said controller to implement the control techniques described herein (including some or all of the functionality or methodologies described herein). The set of instructions could be embedded in said one or more electronic processors. Alternatively, the set of instructions could be provided as software to be executed in said controller. The controller may be implemented in software run on one or more processors. One or more other controllers may be implemented in software run on one or more processors, optionally the same one or more processors as the first controller. Other arrangements are also useful.

In an illustrative embodiment such as that shown in FIG. 3, the controller 46 comprises an electronic processor 47 having one or more electrical inputs and one or more electrical outputs. The example controller 46 further includes an electronic memory device 49 that is part of or electrically connected to the processor 47, and that is accessible by processor 47, In an embodiment, memory device 49 has stored therein or thereon instructions for software, firmware, programs, algorithms, scripts, applications, information etc. that may govern all or part of the methodologies described herein, and that may be executed and/or used by processor 47 to carry out or perform some or all of the functionality and methodologies described herein. Alternatively, some or all of the aforementioned instructions may be embedded in a computer-readable storage medium (e.g. a non-transitory or non-transient storage medium) that may comprise any mechanism for storing information in a form readable by a machine or electronic processors/computational devices, including, without limitation: a magnetic storage medium (e.g. floppy diskette); optical storage medium (e.g. CD-ROM); magneto optical storage medium; read only memory (ROM); random access memory (RAM); erasable programmable memory (e.g. EPROM ad EEPROM); flash memory; or electrical or other types of medium for storing such information/instructions. Additionally, controller 46 may also be electronically connected to other components of system 22 or vehicle 20 via suitable communications (e.g. CAN bus, SMBus, a proprietary communication link, or through some other arrangement known in the art) and can interact with them when or as required.

The controller 46 in this example embodiment controls the manner in which the indicator 48 provides information to the driver regarding a detected object based upon whether the driver is apparently aware of the detected object. Information regarding the driver's awareness of a detected object allows for adjusting the indication provided to the driver in a manner that makes such indications more useful to the driver and avoids potentially annoying or distracting the driver with indications that the driver does not necessarily need. The example controller 46 receives indications from the gaze detecting means 30 and the brain activity detecting means 32. The control means 46 also receives information from an object detector such as the object detecting means 24.

The computing device or processor 47 schematically represents the portion of the system 20 that is configured or programmed to determine at least an estimation of whether the driver is aware of a detected object based upon the indications from the driver gaze sensor 30 and the brain activity sensor 32. An estimation of driver awareness is considered useful in the disclosed embodiments because an absolute determination regarding driver awareness may not be possible and is not necessary. The estimation corresponds to driver awareness and need not be a determination whether the driver is actually aware.

The controller 46 is schematically illustrated as a single controller device distinct from the various sensors and the indicator. In some embodiments one or more of the described functions of the controller 46 may be accomplished in a controller or processor associated with any of the detectors or the indicator. In other words, the controller 46 may be implemented as a combination of control elements associated with other portions of the system 20 or may be a dedicated computing device comprising components distinct from other portions of the system 20.

The indicator means 48 may comprise a device that produces a visible indication, an audible indication, or a combination of such indications. In an embodiment including visual indications, the indicator means may comprise a heads up display that projects a visual display onto the vehicle windshield 52 or an alternative visual display on the vehicle instrument cluster 54, for example. The indicator means 48 may additionally or alternatively comprise a speaker or audio output device that provide an audible indication. Some examples include a combination of visible and audible indications for the driver regarding a detected object.

The example of FIG. 3 includes data storage 58 associated with the controller 46. The controller 46 in this example is configured to place information in the data storage 58 regarding detected objects and corresponding indications of driver awareness. The data storage 58 is schematically shown separate from the memory 49 because the data storage 58 may be remote from the vehicle and the information placed into the data storage 58 may be utilized by third parties, such as insurance companies or rental companies, for analysis that may be relevant to such a third party. The same device or components used to realize the memory 49 may also provide the storage means for the data storage 58 in some embodiments.

FIG. 4 is a flowchart diagram 60 summarizing an example method performed by the example system 22. At 62, an object is detected that may require a response or at least driver attention. The object detector 24, for example, provides an indication of the detected object to the controller 46. At 64, the controller 46 determines driver gaze information, such as an at least approximate direction of the driver's gaze, based on an indication from the driver gaze sensor 30. Known techniques may be used in an example embodiment for utilizing information from a camera to obtain an approximation of the direction of the driver's gaze as described above.

Some embodiments include determining an at least approximate direction of the driver's gaze and an at least estimated position of the detected object relative to the driver. The controller 46 in such examples may determine whether the driver has looked at or is looking at or in the general direction of the detected object as part of determining the driver's gaze information. If, for example, the direction of the driver's gaze corresponds to the position of the detected object, the controller 46 uses that as an indication that increases the likelihood that the driver is aware of the detected object.

At 66, the controller 46 receives an indication of the driver's brain activity from the brain activity sensor 32. Brain activity involved in recognizing or noticing an object in the path of a vehicle would occur when the driver has at least some awareness of the situation. At 68, depending on the driver's gaze information and the brain activity information, the controller 46 determines whether the driver is aware of the detected object.

The determination of the driver's awareness of a detected object may be approximate or based upon a determined probability that the brain activity indication and driver's gaze indication correspond to driver awareness of the detected object. For example, the controller 46 may use an estimation algorithm for estimating whether an approximated driver's detected gaze direction, an approximated position of a detected object relative to the driver, and brain activity information collectively correspond to driver awareness of the detected object.

At 70, the controller 46 controls any indication provided to the driver by the indicator 48 regarding the detected object. In some embodiments, under selected circumstances the controller 46 does not activate the indicator 48 so that no indication is provided to the driver. This may be used in a situation, for example, when an individual is detected near but outside of the path of the vehicle and the estimation of driver awareness corresponds to the driver being aware of the object. Given the indication of driver awareness, if the object does not enter the path of the vehicle providing an indication can be avoided and it may have been annoying or distracting.

The controller 46 may be programmed according to a variety of predetermined criteria to selectively provide an indication regarding a detected object based on an estimation of driver awareness. Those skilled in the art who have the benefit of this description will realize such criteria to meet their particular needs. One embodiment includes a predisposition to avoid providing any indication when the driver is apparently aware of a detected object and to provide an indication whenever the driver apparently is not aware of the object.

According to one embodiment, warnings or indications from the indicator 48 are not provided when the driver is apparently aware of a detected object. When the driver is apparently not aware, the indication initially is provided at a default level and increased if no estimation of awareness is achieved while the object is still detected as a potential hazard.

In one such embodiment, the controller 46 controls the indicator 48 to provide an indication at an appropriate time by initially providing the indication at a default level. The controller 46 in such an embodiment can modify operation of the indicator 48 based on continued monitoring or consideration of the determined driver awareness status. For example, if the detected object corresponds to an expected hazard and the driver does not appear to be aware of that object, the controller 46 may control the indicator 48 and change the indication from a default level to attempt to gain the driver's attention regarding the detected object. If the indicator provides an audible indication, the controller 48 may increase the volume or change the tone or frequency of the indication to increase an effect of the indication and increase the likelihood that the driver will be alerted to the detected object. If the indicator provides a visible indication, the controller 46 may change the size, brightness or intensity of the indication or alter its color in a manner that is designed to increase the likelihood that the driver will become aware of the detected object. The controller 46 may alter one or more such characteristics of the indication to increase the intended effect of the indication (e.g., to increase the driver's awareness of the detected object).

On the other hand, if information regarding the driver's gaze and brain activity indicates that the driver is aware of the detected object, the controller 46 may alter one or more characteristics of the indication from the indicator 48 to reduce its effect on the driver. For example, the volume of an audible indication may be reduced; the color of a visible indication may change; or the size, brightness, or intensity of a visible indication may be reduced. Altering the indication when the driver is apparently aware of a detected object reduces the likelihood that the indication would become annoying or potentially distracting to the driver. Alternatively, the indication may be turned off based on an estimation of driver awareness of the object.

In some embodiments, the controller 46 distinguishes between potential hazards, such as objects near a path of the vehicle, and actual hazards, such as an object directly in the path of the vehicle. Such a controller 46 always activates an indication when an actual hazard is detected regardless of whether the driver is apparently aware of the object but selectively activates an indication when a potential hazard has been detected. It is also possible in some embodiments to decide whether to provide an indication or to change an indication based on a determination that the driver has taken action to avoid the detected object, such as determining that the vehicle brakes have been actuated.

Another feature of some embodiments is to provide an indication to the driver when the system 20 is not able to recognize or obtain any indication regarding the driver's gaze. Such an indication may prompt the driver to change a circumstance that may be impeding the system from detecting the driver's gaze, such as moving something that is in the gaze detector's field of vision or that is obscuring the driver's eyes from camera view.

Considering the indications from the brain activity sensor 32 and the driver gaze sensor 30 allows the controller 46 to determine whether the driver's detected gaze and detected brain activity correspond to the driver being aware of a detected object. One feature of the disclosed example embodiment is that it utilizes a combination of a gaze detection indication and brain activity indication to provide information regarding the driver's awareness and to control any indications based on the estimation of driver awareness.

The preceding description is illustrative rather than limiting in nature. Variations and modifications to the disclosed examples may become apparent to those skilled in the art that do not necessarily depart from the essence of the contribution to the art provided by the disclosed embodiments. The scope of legal protection can only be determined by studying the following claims.

1. A system, comprising:
object detecting means for providing an indication of an object in a vicinity of a vehicle;
at least one indicator means for providing an indication regarding the detected object to a driver;
gaze detecting means for providing an indication of a vehicle driver's gaze;
brain activity detecting means for providing an indication of the driver's brain activity; and
control means for controlling any indication from the indicator means regarding the detected object based upon an indication from the gaze detecting means and the brain activity detecting means corresponding to an estimation of driver awareness of the detected object.

2. The system of claim 1, wherein the control means selectively does not provide any indication from the indicator means when the indication from the gaze detecting means and the brain activity detecting means correspond to an estimation that the driver is aware of the detected object.

3. The system of claim 1, wherein
the indicator means provides an indication regarding the detected object for the driver; and
the control means
alters at least one characteristic for reducing an effect of the indication from the indicator means regarding the detected object when the indication from the gaze detecting means and the brain activity detecting means correspond to an estimation that the driver is aware of the detected object; or
alters at least one characteristic for increasing an effect of the indication from the indicator means regarding the detected object when the indication from the gaze detecting means and the brain activity detecting means correspond to an estimation that the driver is unaware of the detected object.

4. The system of claim 3, wherein
the indication regarding the detected object is at least one of audible or visible;
the at least one characteristic is at least one of tone, frequency or volume if the indication regarding the detected object is audible; and
the at least one characteristic is at least one of size, brightness, color or intensity if the indication regarding the detected object is visible.

5. The system of claim 1, wherein
the at least one object detecting means comprises at least one of
at least one camera,
at least one stereoscopic camera system,
at least one ultrasonic sensor, or
at least one radar detector.

6. The system of claim 1, wherein the at least one gaze detecting means comprises at least one camera having a field of vision situated to capture images of the driver's eyes.

7. The system of claim 1, wherein said control means comprises:
an electronic processor having an electrical input for receiving one or more signals from the object detecting means, the gaze detecting means and the brain activity detecting means; and
an electronic memory device electrically coupled to the electronic processor, the electronic memory device having stored instructions,
wherein controlling any indication from the indicator means comprises the electronic processor being configured to access the memory device and execute the instructions such that the electronic processor is operable to determine an estimation of driver awareness of the detected object based on said signals received from the object detecting means, the gaze detecting means and the brain activity detecting means, and to control said indication based on said determined estimation of driver awareness.

8. The system of claim 1, wherein the control means is configured to
determine an at least approximate direction of the driver's gaze based on the indication from the at least one gaze detecting means;
determine an at least approximate position of the detected object relative to the driver; and
determine whether the determined direction of the driver's gaze corresponds to the driver looking toward the determined position of the detected object.

9. The system of claim 1, wherein the at least one brain activity detecting means comprises a brain wave sensor configured to detect small electrical impulses or signals indicative of brain activity through the driver's skin.

10. The system of claim 1, wherein
the control means comprises a processor and a data storage associated with the processor; and
wherein the processor places information in the data storage regarding detected objects and corresponding driver awareness estimations.

11. A vehicle comprising the system of claim 1.

12. A method, comprising the steps of:
detecting an object in a vicinity of a vehicle;
detecting a vehicle driver's gaze;
detecting the driver's brain activity;
determining whether indications of the detected driver's gaze and the detected driver's brain activity correspond to an estimation of driver awareness of the detected object; and
controlling any indication provided to the driver regarding the detected object based upon the determination regarding driver awareness.

13. The method of claim 12, comprising
not providing any indication regarding the detected object when the indications of the driver's gaze and brain activity correspond to an estimation that the driver is aware of the detected object.

14. The method of claim 12, comprising
providing the indication regarding the detected object for the driver; and
(i) altering at least one characteristic to reduce an effect of the indication regarding the detected object when the indications of the driver's gaze and brain activity correspond to an estimation that the driver is aware of the detected object; or
(ii) altering at least one characteristic to increase an effect of the indication regarding the detected object when the indications of the driver's gaze and brain activity correspond to an estimation that the driver is unaware of the detected object.

15. The method of claim 14, wherein
the indication regarding the detected object is at least one of audible or visible;
the at least one characteristic is at least one of tone, frequency or volume if the indication regarding the detected object is audible; and
the at least one characteristic is at least one of size, brightness, color or intensity if the indication regarding the detected object is visible.

16. The method of claim 12, comprising detecting the object using at least one of
at least one camera,
at least one stereoscopic camera system,
an ultrasonic sensor, or
a radar detector.

17. The method of claim 12, comprising detecting the driver's gaze using a camera having a field of vision situated to capture images of the driver's eyes.

18. The method of claim 12, comprising
determining an at least approximate direction of the driver's gaze based on the indication 30 of the driver's gaze;
determining an at least approximate position of the detected object relative to the driver; and
determining whether the determined direction of the driver's gaze corresponds to the driver looking toward the determined position of the detected object.

19. The method of claim 12, comprising using at least one brain wave sensor configured to detect small electrical impulses or signals indicative of brain activity through the driver's skin for
detecting the driver's brain activity.

20. The method of claim 12, comprising
storing information in a data storage regarding detected objects and corresponding driver awareness estimations.

21. A vehicle comprising detecting means and control means configured to perform the method of claim 12.

22. The system of claim 1, wherein the control means controls the indicator means to provide an indication to the driver when there is insufficient information regarding the driver's gaze.

23. The method of claim 12, comprising
determining that there is insufficient information regarding the driver's gaze; and
providing an indication to the driver configured to prompt the driver to change a circumstance interfering with detecting the driver's gaze.
